(19) United States
(12) Patent Application Publication
(10) Pub. No.: US 2004/0253133 A1
(43) Pub. Date: Dec. 16, 2004

(54) Scroll compressor

(76) Inventors: Hiroyuki Gennami, Kariya-shi (JP); Ken Suitou, Kariya-shi (JP); Kazuya Kimura, Kariya-shi (JP); Kazuhiro Kuroki, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 10/814,895

(22) Filed: Mar. 30, 2004

(30) Foreign Application Priority Data
Mar. 31, 2003 (JP) 2003-097246

(51) Int. Cl. F04C 18/00; F03C 2/00

(52) U.S. Cl. 418/55.1; 418/55.6; 418/179; 417/410.5

(57) ABSTRACT

A scroll compressor has a suction chamber, a stationary scroll and a movable scroll. The stationary scroll has a circumferential wall and a stationary volute portion. The movable scroll has a movable base plate and a movable volute portion. A circumferential surface of the movable base plate and an inner surface of the circumferential wall form a sealing portion at sections located close to each other with a narrow clearance. The sealing portion moves along the inner surface of the circumferential wall as the movable scroll orbits. Lubricating oil in a bottom portion of a suction chamber is supplied to a compression chamber defined by the volute portions from the suction chamber. This effectively utilizes lubricating oil retained in the bottom portion of the suction chamber

### BACKGROUND OF THE INVENTION

The present invention relates to a scroll compressor used, for example, in a vehicle air conditioner.

A typical scroll compressor has a stationary scroll and a movable scroll. The stationary scroll is fixed to a housing, and has a base plate and a volute portion. The movable scroll has a base plate and a volute portion. The volute portions intermesh. When the movable scroll orbits, each of compression chambers defined between the volute portions is moved toward the center of the volute portions, while the volume of the compression chamber is progressively decreased. Accordingly, refrigerant gas is compressed.

Japanese Laid-Open Patent Publication No. 2002-295369 discloses an electric scroll compressor that lubricates an orbiting mechanism that permits a movable scroll to orbit relative to a stationary scroll. The scroll compressor of the publication also improves the sealing property of compression chambers against a compression reaction force in a thrust direction applied to the movable scroll. Specifically, the scroll compressor has a back pressure chamber at the back side of the base plate of the movable scroll. The back pressure chamber surrounds the orbiting mechanism. Lubricating oil the pressure of which corresponds to a discharge pressure is retained in a bottom portion of a discharge chamber. The lubricating oil is guided to the back pressure chamber so that the movable scroll is urged toward the stationary scroll. Accordingly, the sealing property of the compression chambers is improved.

In the electric scroll compressor of the publication, lubricating oil that lubricates the orbiting mechanism and increases the back pressure falls by the self weight down to a motor accommodating chamber through an oil bleed passage having a constriction. The lubricating oil is then temporarily retained in a reservoir formed in the bottom of the motor accommodating chamber. Thereafter, the lubricating oil is conveyed to a bottom portion of a suction chamber located outward of the volute portions through a conveying passage.

After conveyed to the suction chamber, the lubricating oil is drawn into the compression chambers together with refrigerant gas along with suction of the refrigerant gas into the compression chambers caused by orbiting motion of the movable scroll. The lubricating oil then lubricates sliding surfaces. However, since the circumferential surface of the base plate of the movable scroll is spaced from the inner surface of the housing that defines the suction chamber, the base plate itself does not function as a pump. Therefore, a certain amount of lubricating oil is always retained in a bottom portion of the suction chamber. The amount of the oil increases as the speed of the compressor is decreased. For example, providing the conveying passage at a bottom portion of the reservoir does not sufficiently reduce the amount of retained lubricating oil. In other words, the configuration does not permit the lubricating oil to be effectively utilized.

When used in a vehicle air conditioner, the above described electric scroll compressor has the following drawbacks. The reservoir for lubricating oil is formed in the bottom of the motor accommodating chamber. Therefore, when a significant amount of liquid refrigerant returns to the compressor from a refrigeration circuit, mixture of the lubricating oil and the liquid refrigerant stays in the lubricating oil reservoir. The coils of the motor and other components can be impregnated with the mixture. In a typical electric scroll compressor, polyol ester (POE) is used as lubricating oil, so that the lubricating oil exerts a sufficient insulating performance even if mixed with liquid refrigerant. An electric compressor using such lubricant oil has no drawbacks when applied to an ordinary air conditioner. However, in vehicle air conditioners, polyalkylene glycol (PAG) is predominantly used as lubricating oil for belt driven compressors. When mixed with liquid refrigerant, PAG significantly degrades the insulating property of the liquid refrigerant. When performing maintenance of such a vehicle air conditioner, PAG can be mixed with liquid refrigerant. If wire connections and stator coils are impregnated with such mixture of the lowered insulating property, leakage of electricity can occur.

### SUMMARY OF THE INVENTION

Accordingly, it is a main objective of the present invention to effectively utilize lubricating oil retained in a bottom portion of a suction chamber.

Another objective of the present invention is, in addition to the above objective, to prevent mixture of liquids having a lowered insulating property from staying in a motor accommodating chamber during operation of an electric scroll compressor.

A further objective of the present invention is to prevent a stator coil of an electric motor from being impregnated with the mixed liquid, thereby preventing leakage of electricity at the coil

To achieve the foregoing and other objectives and in accordance with the purpose of the present invention, a scroll compressor having a housing, a pressure receiving area, a stationary scroll, a movable scroll, and a suction chamber is provided. The housing has a stationary wall. The pressure receiving area is in the housing. The stationary scroll has a stationary base plate, a stationary volute portion, and a circumferential wall. The stationary base plate is fixed to the housing and has a first face and a second face. The first and second faces are oriented in the opposite directions from each other. The stationary volute portion extends from the first face of the stationary base plate and has a sealing end face. The circumferential wall is located around the stationary base plate. With respect to a direction perpendicular to the first face, the circumferential wall extends further from the first face than the stationary volute portion. The stationary volute portion has an extended portion that extends for a predetermined distance along an inner surface of the circumferential wall from an outer end of the stationary volute portion. A section of the sealing end face that corresponds to the extended portion functions as a pump chamber defining face. The movable scroll has a movable base plate and a movable volute portion. The stationary base plate has a circumferential surface, a first face, and a second face. The first and second faces are oriented in the opposite directions from each other. The first face of the movable base plate faces the sealing end face. The volute portions are engaged with each other to form a gas compression chamber in between. As the movable scroll orbits about an axis of the stationary scroll, the gas compression chamber is moved from an outer portion toward the center of the stationary volute portion. Accordingly, the volume of the gas compression chamber is decreased to compress gas. A section of the first face of the movable base plate that is close to the circumference contacts the pump chamber defining face. The second face of the movable base plate has a section that either contacts the pressure receiving surface or is located close to the pressure receiving surface with an infinitesimal clearance. The suction chamber is located radially outside of the volute portions. The circumferential surface of the movable base plate and an inner surface of the circumferential wall form a sealing portion at sections contacting each other or at sections located close to each other with a narrow clearance. The sealing portion moves along the inner surface of the circumferential wall as the movable scroll orbits. When the sealing portion is located in a lower portion of the suction chamber, a pump chamber for lubricating oil is defined by the sealing portion, the pump chamber defining face, the pressure receiving area, the inner surface of the circumferential wall, and the circumferential surface of the movable base plate.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view illustrating an electric scroll compressor according to one embodiment of the present invention;

FIG. 2 is a cross-sectional view illustrating a compression mechanism provided in the compressor shown in FIG. 1;

FIG. 3 is an enlarged cross-sectional view illustrating a section including a back pressure chamber and an elastic body of the compressor shown in FIG. 1;

FIG. 4 is an exploded perspective view illustrating the shaft supporting member, the elastic body, the stationary scroll, and the cover provided in the compressor shown in FIG. 1;

FIG. 5 is a diagram showing operation of the pump chamber when the movable scroll in the compressor shown in FIG. 1 orbits;

FIG. 6 is a diagram showing operation of the pump chamber when the movable scroll orbits;

FIG. 7 is a diagram showing operation of the pump chamber when the movable scroll orbits; and

FIG. 8 is a diagram showing operation of the pump chamber when the movable scroll orbits.

### DETAILED DESCRIPTION OF THE PREFERRED EMBODIMENTS

In the drawings, like numerals are used for like elements throughout.

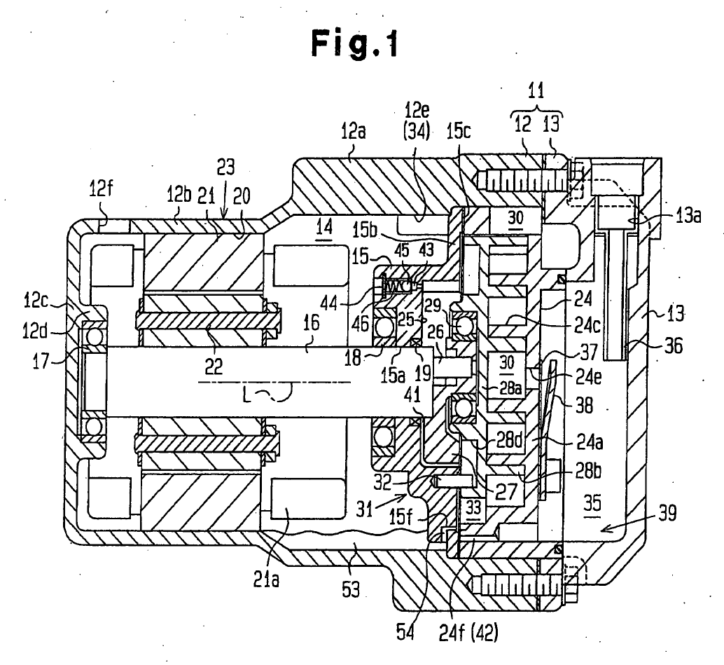

A first embodiment of the present invention will now be described with reference to FIGS. 1 to 8.

As shown in FIG. 1, an electric scroll compressor used in a vehicle air conditioner has a compressor housing 11. The compressor housing 11 is formed of a first housing member 12 and a second housing member 13, which are aluminum alloy castings fastened to each other with bolts. The first housing member 12 is shaped like a cylinder having a bottom and includes a large diameter portion 12a, a small diameter portion 12b, and a bottom portion 12c. The small diameter portion 12b is integrally formed with the large diameter portion 12a at the left end of the large diameter portion 12a. The bottom portion 12c is integrally formed with the small diameter portion 12b at the left end of the small diameter portion 12b. The second housing member 13 is shaped like a cylinder having a bottom. A sealed space 14 is defined in the housing 11. The sealed space 14 is encompassed by the housing members 12, 13.

A cylindrical shaft supporting portion 12d extends from a center portion of the inner surface of the bottom portion 12c, which is a part of the first housing member 12. A shaft supporting member 15 is fitted and fixed to an open end of the large diameter portion 12a of the first housing member 12. The shaft supporting member 15 functions as a stationary wall and has a through hole 15a in the center. A rotary shaft 16 is accommodated in the first housing member 12. The left end of the rotary shaft 16 is rotatably supported by the shaft supporting portion 12d with a bearing 17 in between. The left end of the rotary shaft 16 is rotatably supported by the through hole 15a of the shaft supporting member 15 with the bearing 18 in between. A sealing member 19 is located between the shaft supporting member 15 and the rotary shaft 16 to seal the rotary shaft 16. Accordingly, a motor accommodating chamber 20 is defined in a left portion of the sealed space 14 as viewed in FIG. 1. The shaft supporting member 15 is also a partition wall of the motor accommodating chamber 20.

In the motor accommodating chamber 20, a stator 21 having a coil 21a is located on the inner surface of the small diameter portion 12b of the first housing member 12. In the motor accommodating chamber 20, a rotor 22 is fixed to the rotary shaft 16. The rotor 22 is located radially inward of the stator 21. The small diameter portion 12b, the shaft supporting member 15, the rotary shaft 16, the stator 21, and the rotor 22 form an electric motor 23. When electricity is supplied to the coil 21a of the stator 21, the rotary shaft 16 and the rotor 22 rotate integrally.

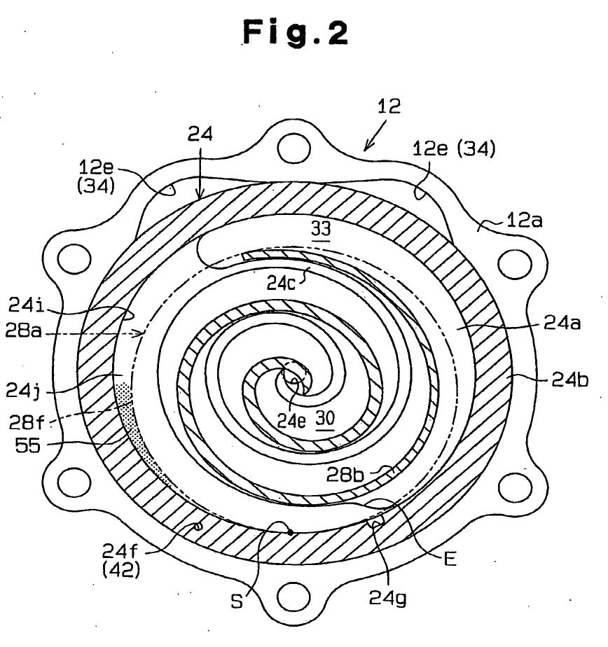

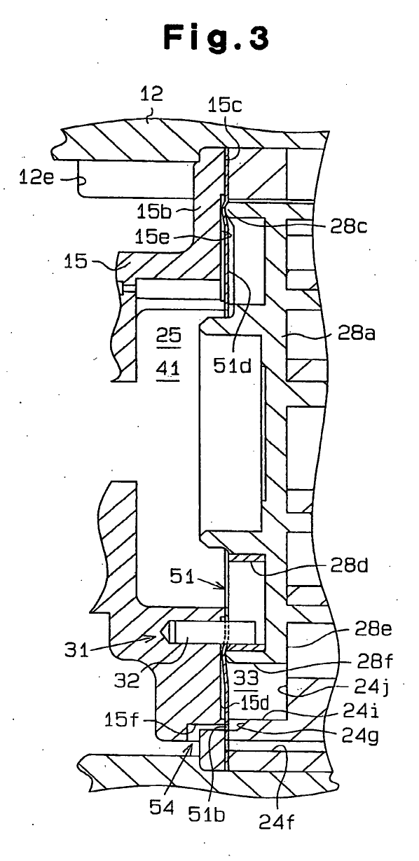

In the first housing member 12, a stationary scroll 24 is located at the open end of the large diameter portion 12a. The stationary scroll 24 includes a disk-shaped stationary base plate 24a, a circumferential wall 24b, and a volute portion 24c. The circumferential wall 24b is integrally formed with and arranged lateral to the stationary base plate 24a. The volute portion 24c is also integrally formed with the stationary base plate 24a. The volute portion 24c is extended from a front side (left side as viewed in FIG. 1) of the stationary base plate 24a and inside the circumferential wall 24b (see FIG. 2). A flange portion 15b is integrally formed with the outer circumferential portion of the shaft supporting member 15. The stationary scroll 24 contacts the flange portion 15b at the distal end face of the circumferential wall 24b (see FIG. 3). Therefore, in the sealed space 14, the stationary base plate 24a and the circumferential wall 24b of the stationary scroll 24, the shaft supporting member 15, and the sealing member 19 sealing the rotary shaft 16 define a scroll accommodating chamber 25 between the shaft sealing member 15 and the stationary scroll 24.

An eccentric shaft 26 is located at the distal end face of the rotary shaft 16. The eccentric shaft 26 is displaced from an axis L of the rotary shaft 16 and is located in the scroll accommodating chamber 25. A bushing 27 is fitted and fixed to the eccentric shaft 26. A movable scroll 28 is rotatably supported by the bushing 27 with a bearing 29 in between. The movable scroll 28 is accommodated in the scroll accommodating chamber 25. The movable scroll 28 includes a disk-shaped movable base plate 28a and a movable volute portion 28b integrally formed with a first face, or the front end face (right end face as viewed in FIG. 1), of the movable base plate 28a. An annular projection 28c, which is annular when viewed along a thrust direction, is integrally formed with the movable base plate 28a on the peripheral portion. The annular projection 28c faces the flange portion 15b (see FIG. 3). The surface of the movable scroll 28 is plated with nickel phosphorus (Ni—P). The stationary volute portion 24c has a sealing end face 24h, which faces a front surface 28e of the movable base plate 28a (see FIGS. 1, 3, and 4).

The stationary scroll 24 and the movable scroll 28 intermesh at the volute portions 24c, 28b in the scroll accommodating chamber 25. The distal end face of each of the volute portions 24c, 28b contacts respectively the base plate 28a, 24a of the other scroll 28, 24. Therefore, the base plate 24a and the stationary volute portion 24c of the stationary scroll 24 and the base plate 28a and the movable volute portion 28b of the movable scroll 28 define a compression chamber 30 in the scroll accommodating chamber 25.

Anti-rotation mechanism 31 is provided between the movable base plate 28a of the movable scroll 28 and the shaft supporting member 15, which faces the movable base plate 28a. The anti-rotation mechanism 31 includes circular holes 28d formed in the peripheral portion of a second face, or the back, of the movable base plate 28a of the movable scroll 28 and pins 32 (only one is shown in the drawing) projecting from the flange portion 15b of the shaft supporting member 15. The pins 32 are loosely fitted in the circular holes 28d.

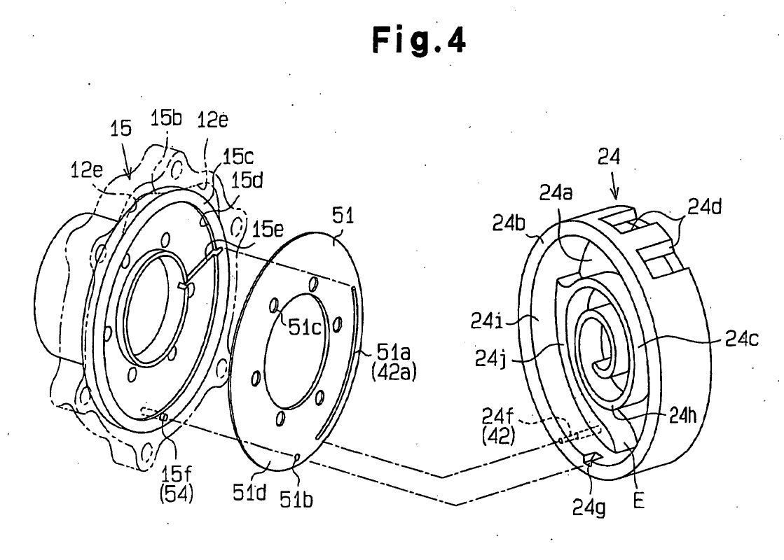

In the scroll accommodating chamber 25, a suction chamber 33 is defined between the circumferential wall 24b of the stationary scroll 24 and the outermost portion of the movable volute portion 28b of the movable scroll 28. In an upper portion of the circumferential wall 24b of the stationary scroll 24, symmetric two recesses 24d are formed as shown in FIG. 4. In an inner upper surface of the large diameter portion 12a of the first housing member 12, symmetric two recesses 12e are formed to correspond to the recesses 24d. A space between the inner surfaces of the recesses 12e and the outer surface of the flange portion 15b of the shaft supporting member 15, and the recesses 24d of the circumferential wall 24b define a fluid passage, which is a suction passage 34 in this embodiment. The suction passage 34 connects an upper portion of the motor accommodating chamber 20 with the suction chamber 33.

In a left outer portion of the small diameter portion 12b of the first housing member 12 as viewed in FIG. 1, a suction port 12f is formed to permit the motor accommodating chamber 20 to communicate with the outside. An external pipe is connected to the suction port 12f. The external pipe is connected to an evaporator of an external refrigerant circuit (not shown). Therefore, low pressure refrigerant gas is drawn into the suction chamber 33 from the external refrigerant circuit through the suction port 12f, the motor accommodating chamber 20, which functions as a suction passage, and the suction passage 34. Although not illustrated, grooves extending in a thrust direction are formed on the outer circumferential surface of the stator 21. The grooves function as passages for refrigerant gas.

A discharge chamber 35 is defined between the second housing member 13 and the stationary scroll 24. A discharge hole 24e is formed in a center portion of the base plate 24a of the stationary scroll 24. The discharge hole 24e connects the compression chamber 30 with the discharge chamber 35 when the compression chamber 30 is at the center of the scrolls 24, 28. In the discharge chamber 35, a discharge valve 37, which is a reed valve, is provided on the stationary scroll 24 to open and close the discharge hole 24e. The opening degree of the discharge valve 37 is limited by a retainer 38 fixed to the stationary scroll 24. A discharge port 13a is formed in the second housing member 13. The discharge port 13a communicates with the discharge chamber 35. An external pipe is connected to the discharge port 13a. The external pipe is connected to a condenser of the external refrigerant circuit (not shown). An oil separator 36 is attached to the discharge port 13a to separate lubricating oil from high pressure refrigerant gas. Therefore, high pressure refrigerant gas in the discharge chamber 35 is discharged to the external refrigerant circuit through the discharge port 13a after the oil separator separates lubricating oil from the refrigerant gas. A first reservoir chamber 39 is formed in a bottom portion of the discharge chamber 35 to retain lubricating oil that has been separated from refrigerant by the oil separator 36.

When the rotary shaft 16 is rotated by the electric motor 23, the movable scroll 28 is caused to orbit about the axis (the axis L of the rotary shaft 16) by the eccentric shaft 26. The movable scroll 28 is prevented from rotating by the anti-rotation mechanism 31, but is only permitted to orbit. The orbiting motion of the movable scroll 28 moves the compression chamber 30 from an outer portion of the volute portions 24c, 28b of the scrolls 24, 28 toward the center of the scrolls 24, 28 as decreasing the volume of the compression chamber 30. Accordingly, low pressure refrigerant that has been drawn into the compression chamber 30 from the suction chamber 33 is compressed. The compressed high pressure refrigerant gas is discharged to the discharge chamber 35 through the discharge port 24e through the discharge valve 37.

As shown in FIGS. 1 and 3, a back pressure chamber 41 is defined in the scroll accommodating chamber 25 at the back of the base plate 28a of the movable scroll 28. The back pressure chamber 41 and the first reservoir chamber 39 of the discharge chamber 35, or a discharge pressure zone, are connected with each other by a pressurized oil supply passage 42. The pressurized oil supply passage 42 has a constriction 42a. High pressure lubricating oil in the first reservoir chamber 39 at a lower portion of the discharge chamber 35 contains a small amount of refrigerant gas. The high pressure lubricating oil is supplied to the back pressure chamber 41 and urges the movable scroll 28 toward the stationary scroll 24.

An oil bleed passage 43 is formed in the shaft supporting member 15 to connect the back pressure chamber 41 with the motor accommodating chamber 20 (suction pressure zone). An adjuster valve 44 is located in the oil bleed passage 43 of the shaft supporting member 15. The adjuster valve 44 adjusts the opening degree of the oil bleed passage 43 according to the difference between the pressure in the back pressure chamber 41 and the pressure in the motor accommodating chamber 20. The adjuster valve 44 includes a ball valve 45 and a coil spring 46, and operates to maintain the pressure difference between the back pressure chamber 41 and the motor accommodating chamber 20 to a constant value. Therefore, when the electric scroll compressor operates normally, the adjuster valve 44 maintains the pressure in the back pressure chamber 41, or an urging force of the movable scroll 28 based on the pressure in the back pressure chamber 41, to a constant value.

As shown in FIGS. 1, 3 and 4, in the scroll accommodating chamber 25, an annular elastic body 51 is located between the flange portion 15b of the shaft supporting member 15 and the circumferential wall 24b of the stationary scroll 24. The elastic body 51 is made, for example, of metal such as carbon steel. A peripheral portion of the elastic body 51 is held between the flange portion 15b of the shaft supporting member 15 and the circumferential wall 24b of the stationary scroll 24, so that the elastic body 51 is fixed in the scroll accommodating chamber 25.

As shown in FIG. 4, an arcuate elongated hole 51a is formed in a peripheral portion of the elastic body 51. The elongated hole 51a and a space encompassed by a contact surface 15c of the flange portion 15b of the shaft supporting member 15 and a distal end face of the circumferential wall 24b of the stationary scroll 24 form a section (constriction 42a) of the pressurized oil supply passage 42 connecting the first reservoir chamber 39 with the back pressure chamber 41. The lower end of the elongated hole 51a is connected with the first reservoir chamber 39 by an oil passage 24f formed in the circumferential wall 24b of the stationary scroll 24. The upper end of the elongated hole 51a is connected with the back pressure chamber 41 by a wide annular groove 15d and a linear groove 15e, which are formed in the contact surface 15c of the shaft supporting member 15. The oil passage 24f, the elongated hole 51a, and the grooves 15d, 15e form the pressurized oil supply passage 42.

As shown in FIG. 3, the elastic body 51 is installed while being elastically deformed by the annular projection 28c of the movable scroll 28. The elasticity of the elastic body 51 maintains the sealing property between the elastic body 51 and the contact surface of the annular projection 28c, and urges the movable scroll 28 toward the stationary scroll 24.

As shown in FIG. 1, a second reservoir chamber 53 is formed by bulging downward a lower portion of the large diameter portion 12a of the first housing member 12. The second reservoir chamber 53 retains a great amount of lubricating oil conducted from the back pressure chamber 41 through the oil bleed passage 43.

An oil return passage 54 is formed in the flange portion 15b of the shaft supporting member 15 and a lower portion of the elastic body 51. The oil return passage 54 guides lubricating oil retained in the second reservoir chamber 53 to the suction chamber 33. The oil return passage 54 includes a through hole 15f formed in the flange portion 15b, a hole 51b formed in a portion of the elastic body 51 that corresponds to the through hole 15f, a recess 24g formed in a portion of the distal end face of the circumferential wall 24b that corresponds to the hole 51b. Lubricating oil retained in the second reservoir chamber 53 is drawn to a bottom portion of the suction chamber 33 through the oil return passage 54 by orbiting motion of the movable scroll 28. The lubricating oil is then drawn into the compression chamber 30 with refrigerant gas to lubricate sliding surfaces of the compression mechanism. Pin holes 51c are formed in an inner portion of the elastic body 51. The pins 32 of the anti-rotation mechanism 31 are inserted in the pin holes 51c.

The characteristic configuration of the present invention will now be explained with reference to FIGS. 2 to 4.

As shown in FIG. 4, the circumferential wall 24b of the stationary scroll 24 projects further than the sealing end face 24h of the stationary volute portion 24c in the axial direction. The stationary volute portion 24c has an extended portion that extends for a predetermined distance from the outer end E along the inner surface of the circumferential wall 24b. A section of the sealing end face 24h that corresponds to the extended portion functions as a pump chamber defining face 24j. The pump chamber defining face 24j has a predetermined width with respect to the radial direction. As shown in FIG. 3, a section of the front surface 28e of the movable base plate 28a that is close to the periphery contacts the pump chamber defining face 24j. The annular projection 28c formed on the back of the movable base plate 28a always contacts a pressure receiving area 51d of the elastic body 51, thereby sealing the boundary between the elastic body 51 and the movable base plate 28a.

As shown in FIG. 2, the movable base plate 28a is arranged such that a narrow clearance corresponding to a sealing portion S exists between a part of a circumferential surface 28f of the movable base plate 28a and the inner surface 24i of the circumferential wall 24b. In a state where the sealing portion S is at a lower portion of the suction chamber 33 formed in an outer portion of the volute portions 24c, 28b, the sealing portion S, the pump chamber defining face 24j, the pressure receiving area 51d, the inner surface 24i of the circumferential wall 24b, and the circumferential surface 28f of the movable base plate 28a define a pump chamber 55. In FIG. 2, the pump chamber 55 is represented by a number of dots.

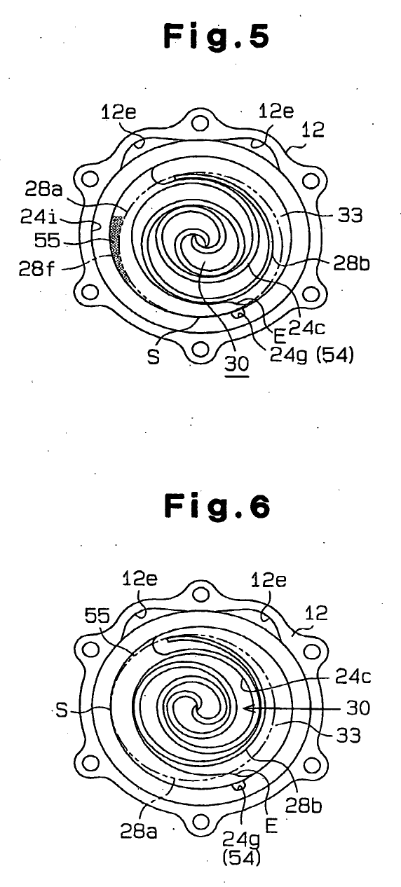

Operation of pumping up lubricating oil by the pump chamber 55 will now be described with reference to FIGS. 5 to 8. The pump chamber 55 pumps up as the movable scroll 28 orbits.

FIG. 5 illustrates a state in which the movable scroll 28 is at the lowermost position, the sealing portion S is at the lowermost position, and lubricating oil in a bottom portion of the suction chamber 33 is drawn into the pump chamber 55. When the movable scroll 28 orbits clockwise from this state, the sealing portion S is moved clockwise along the inner surface 24i. Therefore, the pump chamber 55 is moved upward as shown in FIG. 6 while decreasing its volume. Accordingly, lubricating oil in the pump chamber 55 is supplied to an upper portion of the suction chamber 33. The lubricating oil is then drawn into the compression chamber 30 together with refrigerant gas, and lubricates the sliding surfaces of the compression mechanism.

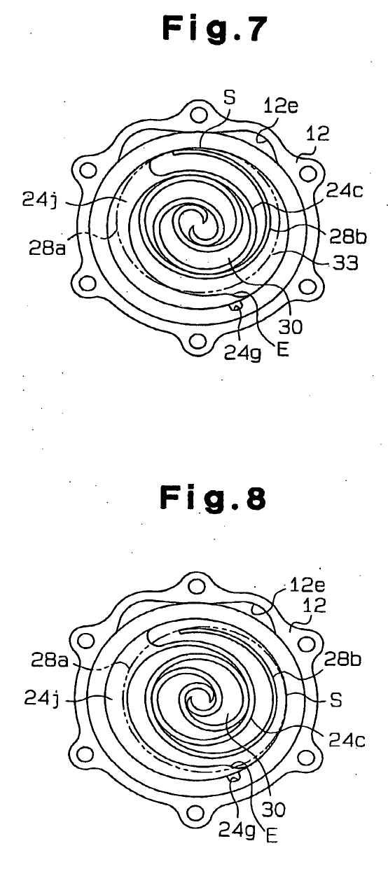

When the movable scroll 28 is in the uppermost position as shown in FIG. 7, the sealing portion S is separated from the pump chamber defining face 24j. As a result, the pump chamber 55 disappears. When the movable scroll 28 orbits by ninety degrees from the state of FIG. 7, the sealing portion S is moved to the rightmost position as shown in FIG. 8. In this state, the sealing portion S has not reached a position corresponding to an outer end E of the pump chamber defining face 24j. Therefore, the pump chamber 55 has not appeared. During the pumping up motion illustrated in FIGS. 5 to 8, lubricating oil in the second reservoir chamber 53 is drawn to the suction chamber 33 through the oil return passage 54. The lubricating oil is then is drawn into the pump chamber 55, which appears after the sealing portion S passes the outer end E of the pump chamber defining face 24j, and moved upward. Thereafter, the lubricating oil is drawn into the compression chamber 30 together with refrigerant gas.

The above embodiment provides the following advantages.

(1) Lubricating oil is retained in the bottom portion of the suction chamber 33 by orbiting motion of the movable scroll 28, and is then drawn into the pump chamber 55. Subsequently, the lubricating oil is moved upward as the sealing portion S moves, and supplied to the compression chamber 30 to lubricate the compression mechanism. Therefore, lubricating oil is prevented from being retained in the bottom portion of the suction chamber 33, and is effectively utilized.

(2) Since no components dedicated for forming the pump chamber 55 are required, the manufacturing cost of the pump chamber 55 is reduced.

(3) Lubricating oil is supplied to the second reservoir chamber 53 from the back pressure chamber 41 through the oil bleed passage 43 and the adjuster valve 44. The lubricating oil is then retained in the second reservoir chamber 53. Lubricating oil in the second reservoir chamber 53 is drawn into the suction chamber 33 by the pumping action of the pump chamber 55 through the oil return passage 54. Therefore, lubricating oil is reliably drawn into the suction chamber 33 from the second reservoir chamber 53. This reliably lubricates the sliding surfaces of the compression mechanism.

(4) The second reservoir chamber 53 is formed in a lower portion of the large diameter portion 12a of the first housing member 12. The second reservoir chamber 53 bulges downward relative to the coil 21a of the stator 21. In the interior of the motor accommodating chamber 20, temporary stopping of the compressor or temporary clogging of the oil return passage 54 can cause lubricating oil contained in refrigerant gas to be retained in the bottom portion of the motor accommodating chamber 20. Even if this is the case, the coil 21a of the stator 21 is not impregnated with liquid that is formed by mixing liquid refrigerant and two or more kinds of lubricating oil and has a lowered insulating property. Therefore, leakage of electricity at the coil 21a is prevented.

(5) The pumping chamber 55 is capable of drawing lubricating oil in the second reservoir chamber 53 through pumping action. Therefore, even if the second reservoir chamber 53 is shallow, excessive amount of lubricating oil is prevented from being retained in the second reservoir chamber 53. Therefore, liquid that is formed by mixing liquid refrigerant and two or more kinds of lubricating oil and has a lowered insulating property is not generated in a great quantity. Thus, leakage of electricity at the coil 21a is prevented.

(6) The movable scroll 28 is urged toward the stationary scroll 24 by high pressure refrigerant gas supplied to the back pressure chamber 41. That is, the movable scroll 28 is urged toward the stationary scroll 24 not only by the urging force generated by elastic deformation of the elastic body 51, but also, by the urging force generated by the pressure of the back pressure chamber 41. These urging forces reliably act against the compression reaction force in the thrust direction acting on the movable scroll 28 during a normal operation of the electric compressor. Thus, the illustrated embodiment, in which sealing members (for example, chip seals) are not provided on the end faces of the volute portions 24c, 28b, the compression chamber 30 is reliably sealed.

The invention may be embodied in the following forms.

The suction port 12f and the recesses 12e of the first housing member 12 may be omitted so that the motor accommodating chamber 20 does not function as a part of the suction gas passage, and the suction port 12f may be formed in the bottom of the large diameter portion 12a. In this case, the oil return passage 54 functions as a fluid passage that connects the bottom portion of the motor accommodating chamber with the suction chamber 33 of the compression mechanism.

In this modified embodiment, liquid refrigerant does not return to the motor accommodating chamber from the refrigeration circuit. Therefore, no mixture of liquid refrigerant and two or more kinds of lubricating oil is generated in the motor accommodating chamber 20. Leakage of electricity at the wire joints and the coil of the electric motor is thus prevented.

The adjuster valve 44 in the oil bleed passage 43 may be replaced by a constriction having a smaller cross-sectional area than the constriction 42a.

The back of the movable base plate 28a may contact the pressure receiving surface of a fixed wall in the housing, and a part of the circumferential surface of the movable base plate 28a may contact the inner surface of the circumferential wall 24b for forming the sealing member.

The suction passage 34, which connects the motor accommodating chamber 20 with the suction chamber 33, may be formed in a lower portions of the large diameter portion 12a and the circumferential wall 24b. Alternatively, the suction passage 34 may be formed in an upper end portions or a lower end portions of the large diameter portion 12a and the circumferential wall 24b.

In the illustrated embodiment, the rotation axis L of the electric motor 23 is arranged horizontally. However, as long as the rotation axis L is substantially horizontal, the axis L may be inclined upward or downward, for example, by 10° relative to a horizontal line.

In the illustrated embodiment, the present invention is applied to an electric scroll compressor. However, the present invention may be applied to a non-electric scroll compressor driven by a vehicle engine. Alternatively, the present invention may be applied to a hybrid compressor, which uses an electric motor and an engine as drive sources

Therefore, the present examples and embodiments are to be considered as illustrative and not restrictive and the invention is not to be limited to the details given herein, but may be modified within the scope and equivalence of the appended claims.

1. A scroll compressor, comprising:
a housing having a stationary wall:
a pressure receiving area being in the housing;
a stationary scroll, wherein the stationary scroll has a stationary base plate, a stationary volute portion, and a circumferential wall, wherein the stationary base plate is fixed to the housing and has a first face and a second face, the first and second faces being oriented in the opposite directions from each other, wherein the stationary volute portion extends from the first face of the stationary base plate and has a sealing end face, wherein the circumferential wall is located around the stationary base plate, wherein, with respect to a direction perpendicular to the first face, the circumferential wall extends further from the first face than the stationary volute portion, wherein the stationary volute portion has an extended portion that extends for a predetermined distance along an inner surface of the circumferential wall from an outer end of the stationary volute portion, and wherein a section of the sealing end face that corresponds to the extended portion functions as a pump chamber defining face;
a movable scroll, wherein the movable scroll has a movable base plate and a movable volute portion, wherein the stationary base plate has a circumferential surface, a first face, and a second face, the first and second faces being oriented in the opposite directions from each other, wherein the first face of the movable base plate faces the sealing end face, wherein the volute portions are engaged with each other to form a gas compression chamber in between, wherein, as the movable scroll orbits about an axis of the stationary scroll, the gas compression chamber is moved from an outer portion toward the center of the stationary volute portion, whereby the volume of the gas compression chamber is decreased to compress gas, wherein a section of the first face of the movable base plate that is close to the circumference contacts the pump chamber defining face, and wherein the second face of the movable base plate has a section that either contacts the pressure receiving surface or is located close to the pressure receiving surface with an infinitesimal clearance; and
a suction chamber located radially outside of the volute portions,
wherein the circumferential surface of the movable base plate and an inner surface of the circumferential wall form a sealing portion at sections contacting each other or at sections located close to each other with a narrow clearance, wherein the sealing portion moves along the inner surface of the circumferential wall as the movable scroll orbits, wherein, when the sealing portion is located in a lower portion of the suction chamber, a pump chamber for lubricating oil is defined by the sealing portion, the pump chamber defining face, the pressure receiving area, the inner surface of the circumferential wall, and the circumferential surface of the movable base plate.

2. The compressor according to claim 1, further comprising an electric motor for causing the movable scroll to orbit, wherein the electric motor has an axis of rotation, wherein the housing defines a motor accommodating chamber that accommodates the electric motor such that the rotation axis of the motor is substantially horizontal, wherein the motor accommodating chamber is configured either such that the pressure in the motor accommodation chamber is substantially equal to the pressure in the suction chamber or such that the motor accommodating chamber forms part of a suction passage that guides gas from the outside to the suction chamber, and wherein a bottom portion of the motor accommodating chamber is connected to a lower portion of the suction chamber through an oil return passage.

3. The compressor according to claim 2, wherein lubricating oil in the bottom portion of the motor accommodating chamber is drawn into the suction chamber by pumping action of the pump chamber through the oil return passage.

4. The compressor according to claim 2, further comprising a discharge chamber, the pressure of which is a discharge pressure, wherein a first reservoir chamber is located in the discharge chamber to store lubricating oil, wherein a back pressure chamber is defined between the second face of the movable base plate and the stationary wall, wherein the back pressure chamber is connected to the first reservoir chamber through a fluid passage having a constriction, and wherein the back pressure chamber is connected to the motor accommodating chamber through an oil bleed passage having a constriction or an adjuster valve.

5. The compressor according to claim 4, wherein a second reservoir chamber is formed at a bottom portion of the motor accommodation chamber, the second reservoir chamber bulging downward.

6. The compressor according to claim 5, wherein lubricating oil in the second reservoir chamber is drawn into the suction chamber by pumping action of the pump chamber through the oil return passage.

7. The compressor according to claim 4, wherein an elastic body is located between the second face of the movable base plate and the stationary wall, and has the pressure receiving area, the elastic body urging the movable scroll toward the stationary scroll, and wherein the elastic body seals the back pressure chamber and the suction chamber from each other.

8. The compressor according to claim 7, wherein a second reservoir chamber is formed at a bottom portion of the motor accommodation chamber, the second reservoir chamber bulging downward, wherein lubricating oil in the second reservoir chamber is drawn into the suction chamber by pumping action of the pump chamber through the oil return passage, and wherein the elastic body is a doughnut-shaped plate and includes a part of the oil return passage.

9. The compressor according to claim 7, wherein an annular projection extends from the second face of the movable base plate, and wherein the annular projection is pressed against the elastic body, thereby sealing the back pressure chamber.

10. The compressor according to claim 1, wherein the surface of the movable scroll is plated with nickel phosphorus.

11. A scroll compressor, comprising:
a housing having a stationary wall:
a pressure receiving area being in the housing;
a stationary scroll having an axis, wherein the stationary scroll is arranged such that the axis is substantially horizontal, wherein the stationary scroll has a stationary base plate, a stationary volute portion, and a circumferential wall, wherein the stationary base plate is fixed to the housing and has a first face and a second face, the first and second faces being oriented in the opposite directions from each other, wherein the stationary volute portion extends from the first face of the stationary base plate and has a sealing end face, wherein the circumferential wall is located around the stationary base plate, wherein, with respect to a direction perpendicular to the first face, the circumferential wall extends further from the first face than the stationary volute portion, wherein the stationary volute portion has an extended portion that extends for a predetermined distance along an inner surface of the circumferential wall from an outer end of the stationary volute portion, and wherein a section of the sealing end face that corresponds to the extended portion functions as a pump chamber defining face;
a movable scroll, wherein the movable scroll has a movable base plate and a movable volute portion, wherein the stationary base plate has a circumferential surface, a first face, and a second face, the first and second faces being oriented in the opposite directions from each other, wherein the first face of the movable base plate faces the sealing end face, wherein the volute portions are engaged with each other to form a gas compression chamber in between, wherein, as the movable scroll orbits about an axis of the stationary scroll, the gas compression chamber is moved from an outer portion toward the center of the stationary volute portion, whereby the volume of the gas compression chamber is decreased to compress gas, wherein a section of the first face of the movable base plate that is close to the circumference contacts the pump chamber defining face, and wherein the second face of the movable base plate has a section that either contacts the pressure receiving surface or is located close to the pressure receiving surface with an infinitesimal clearance; and
a suction chamber defined between the inner surface of the circumferential wall and the circumferential surface of the movable base plate,
wherein the circumferential surface of the movable base plate and an inner surface of the circumferential wall form a sealing portion at sections contacting each other or at sections located close to each other with a narrow clearance, wherein the sealing portion moves along the inner surface of the circumferential wall as the movable scroll orbits, wherein, when the sealing portion is located in a lower portion of the suction chamber, a pump chamber for lubricating oil is defined by the sealing portion, the pump chamber defining face, the pressure receiving area, the inner surface of the circumferential wall, and the circumferential surface of the movable base plate.

12. The compressor according to claim 11, further comprising an electric motor for causing the movable scroll to orbit, wherein the electric motor has an axis of rotation, wherein the housing defines a motor accommodating chamber that accommodates the electric motor such that the rotation axis of the motor is substantially horizontal, wherein the motor accommodating chamber is configured either such that the pressure in the motor accommodation chamber is substantially equal to the pressure in the suction chamber or such that the motor accommodating chamber forms part of a suction passage that guides gas from the outside to the suction chamber, and wherein a bottom portion of the motor accommodating chamber is connected to a lower portion of the suction chamber through an oil return passage.

13. The compressor according to claim 12, wherein lubricating oil in the bottom portion of the motor accommodating chamber is drawn into the suction chamber by pumping action of the pump chamber through the oil return passage.

14. The compressor according to claim 12, further comprising a discharge chamber, the pressure of which is a discharge pressure, wherein a first reservoir chamber is located in the discharge chamber to store lubricating oil, wherein a back pressure chamber is defined between the second face of the movable base plate and the stationary wall, wherein the back pressure chamber is connected to the first reservoir chamber through a fluid passage having a constriction, and wherein the back pressure chamber is connected to the motor accommodating chamber through an oil bleed passage having a constriction or an adjuster valve.

15. The compressor according to claim 14, wherein a second reservoir chamber is formed at a bottom portion of the motor accommodation chamber, the second reservoir chamber bulging downward.

16. The compressor according to claim 15, wherein lubricating oil in the second reservoir chamber is drawn into the suction chamber by pumping action of the pump chamber through the oil return passage.

17. The compressor according to claim 14, wherein an elastic body is located between the second face of the movable base plate and the stationary wall, and has the pressure receiving area, the elastic body urging the movable scroll toward the stationary scroll, and wherein the elastic body seals the back pressure chamber and the suction chamber from each other.

18. The compressor according to claim 17, wherein a second reservoir chamber is formed at a bottom portion of the motor accommodation chamber, the second reservoir chamber bulging downward, wherein lubricating oil in the second reservoir chamber is drawn into the suction chamber by pumping action of the pump chamber through the oil return passage, and wherein the elastic body is a doughnut-shaped plate and includes a part of the oil return passage.

19. The compressor according to claim 17, wherein an annular projection extends from the second face of the movable base plate, and wherein the annular projection is pressed against the elastic body, thereby sealing the back pressure chamber.

20. The compressor according to claim 11, wherein the surface of the movable scroll is plated with nickel phosphorus.
